(19) United States
(12) Patent Application Publication
(10) Pub. No.: US 2023/0326653 A1
(43) Pub. Date: Oct. 12, 2023

(54) SUPPORT STRUCTURE AND TRANSFORMER INCLUDING A SUPPORT STRUCTURE

(71) Applicant: HITACHI ENERGY SWITZERLAND AG, Baden (CH)

(72) Inventors: QingJun SUN, Shanghai (CN); Ye XU, Shanghai (CN)

(21) Appl. No.: 18/023,866

(22) PCT Filed: Jun. 30, 2021
(86) PCT No.: PCT/EP2021/071487

§ 371 Date: Feb. 28, 2023

(30) Foreign Application Priority Data
Jul. 19, 2021 (CN) 202110813446.6

(51) Int. Cl. H01F 27/10

(52) U.S. Cl. CPC H01F 27/10

(57) ABSTRACT

A support structure is configured to be arranged at least partially in a space provided between at least two coil segments of a transformer. The support structure comprises an elongated body having at least a first side and a second side. The support structure comprises at least one fluid passage opening provided in at least a section of the elongated body. The at least one fluid passage opening is configured to allow a fluid to pass therethrough from the first side to the second side. A transformer has a support structure arranged in a space between at least two coils segments of the transformer.

### CROSS REFERENCE TO RELATED APPLICATIONS

This application is a 35 U.S.C. § 371 national stage application of PCT International Application No. PCT/EP2021/071487 filed on Jul. 30, 2021, which in turn claims priority to Chinese Patent Application No. 202110813446.6, filed on Jul. 19, 2021, the disclosures and content of which are incorporated by reference herein in their entireties.

### BACKGROUND

Transformers are widely used to convert electricity from a first voltage level to a second voltage level, the second voltage level being either higher or lower than the first voltage level.

A transformer generally achieves such a voltage conversion by employing at least one primary coil winding and at least one secondary coil winding, each being made of electrical conductors. Each of the at least one primary coil winding and the at least one secondary coil winding are wound around a ferromagnetic core by a plurality of turns.

The transformer may comprise a plurality of primary coil windings and/or a plurality of secondary coil windings. Such transformers are referred to as multi-winding transformers. The plurality of primary coil windings and/or secondary coil windings, respectively, may be connected in series or in parallel. Furthermore, the plurality of primary coil windings and/or secondary coil windings, respectively, may also each be independent, i.e., unconnected, depending on the desired functionality of the transformer.

Transformers, such as of the types described above, generate heat during operation due to a power loss dissipated by the transformer in the form of heat. Such a power loss of the transformer comprises core losses and coil losses.

Thus, the core and the coil windings of the transformer generate heat within the transformer, which may be transferred away from the transformer to achieve a better performance, a longer lifetime of the transformer and lower operational costs of the transformer.

It is known to immerse the coil windings and/or the core in a liquid, particularly an oil, to insulate and cool the transformer. Transformers having such a configuration are often referred to as oil filled transformers.

As an alternative, besides immersing the coil windings and/or the core in a liquid, it is also known to use other fluids, such as air, to flow through at least a portion of the coil windings of the transformer in order to transfer heat away from the coil windings.

However, deficiencies remain with respect to the efficacy of the cooling means provided in transformers known from the prior art.

Therefore, there is a need to improve the cooling of transformers in order to improve the performance and the lifetime of the transformer and to reduce its operational costs.

### SUMMARY

Thus, the present disclosure describes improved cooling of a transformer, as detailed below.

The present disclosure relates to a support structure according to a first aspect of the disclosure. For example, a support structure may be configured to be arranged at least partially in a space provided within a transformer, in particular to provide support to at least one coil of the transformer, particularly in a space provided between at least two coil segments of a transformer to provide support to the at least two coil segments. The support structure includes an elongated body having at least a first side and a second side, and at least one fluid passage opening provided in at least a section of the elongated body, the at least one fluid passage opening being configured to allow a fluid to pass therethrough, particularly from the first side of the elongated body to the second side of the elongated body.

Various exemplary embodiments of the present disclosure disclosed herein are directed to providing features that will become readily apparent by reference to the following description when taken in conjunction with the accompanying drawings. In accordance with various embodiments, exemplary systems, methods, and devices are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise. The above and other aspects and their implementations are described in greater detail in the drawings, the descriptions, and the claims.

### DESCRIPTION OF THE DRAWINGS

FIG. 1 shows, in a top view, a transformer with a coil block and a plurality of support structures having a first configuration installed therein;

FIG. 2 shows, in a top view, a transformer with a coil block and a plurality of support structures having a second configuration installed therein;

FIG. 3 shows, in a side view, a support structure according to an embodiment of the disclosure;

FIG. 4 shows a cross-section of a support structure according to an embodiment of the disclosure;

FIG. 5 shows, in a side view, a support structure according to an embodiment of the disclosure.

### DETAILED DESCRIPTION

In the following, exemplary embodiments of the disclosure will be described. It is noted that some aspects of any one of the described embodiments may also be found in some other embodiments unless otherwise stated or obvious. However, for increased intelligibility, each aspect will only be described in detail when first mentioned and any repeated description of the same aspect will be omitted.

The support structure of the present disclosure is configured to be arranged at least partially in a space provided between at least two coil segments of a transformer, in particular to provide support to the at least two coil segments. The support structure comprises an elongated body having at least a first side and a second side. The elongated body may have a longitudinal axis extending along a length of the elongated body.

The coils of a transformer may be subjected to forces which may cause one or more of the coils of the transformer to move and/or to be displaced during operation of the transformer. For instance, when a short circuit occurs, the coils of the concerned transformer may be subjected to forces generated in the coils during the short circuit. Such forces may be high enough to cause damage to the coils and/or other components of the transformer.

Thus, structural support to the at least two coil segments may be provided by arranging at least one support structure, particularly a plurality of support structures, at least partially in a space provided between at least two coil segments of a transformer.

As a result, the support structure may prevent the at least two coil segments from moving, or at least reduce movement of the at least two coil segments, at least relative to each other during operation of the transformer.

The support structure, specifically the elongated body, may be fastened, particularly fixedly fastened, to a section of the transformer by one or more fastening means, e.g., by a welding joint, a riveted joint, an adhesive bond, one or more bolts, one or more clamps, and/or further fastening means. Alternatively, the support structure, specifically the elongated body, may not be fastened, at least not fixedly fastened, to the transformer.

The at least two coil segments may form part of one or more primary coil windings which at least partially surround a core of the transformer. The primary coil windings may be low voltage (LV) coil windings of the transformer. The transformer may also comprise one or more secondary coil windings, which may be arranged at least partially around the one or more primary coil windings, in particular in a radial direction, in particular with respect to a winding axis of the primary coil windings and/or the secondary coil windings. The secondary coil windings may be high voltage (HV) coil windings of the transformer having a voltage higher than the low voltage coil windings. Alternatively, the primary coil windings may be high voltage coil windings and the secondary coil windings may be low voltage coil windings of the transformer. Alternatively, the at least two coil segments may form part of the secondary coil windings.

The primary coil windings may be connected to a source of voltage and the secondary coil winding may be connected to a load.

The transformer may be a low voltage, medium voltage or high voltage transformer.

The space, in which the support structure is configured to be arranged, may be a radial space extending radially between a first coil segment and a second coil segment of the at least two coil segments. The space may extend substantially circumferentially, at least partially, about a longitudinal axis of the transformer and/or a winding axis of the at least two coil segments. The space may also extend axially, at least partially, along the longitudinal axis of the transformer and/or the winding axis of the at least two coil segments.

The space may be configured as a cooling duct to allow a fluid, such as a gas or a liquid, to at least partially flow therethrough in order to transfer heat away from the coil segments, and also from the support structure when the support structure is arranged in the space, thus reducing the temperature build-up within the transformer. Further cooling ducts may be arranged elsewhere in the transformer, for instance, within the core, to provide further cooling means.

The transformer may include a plurality of spaces, e.g., cooling ducts, provided between at least two coils segments of a transformer. The plurality of spaces, e.g., cooling ducts, may be interconnected or disconnected with each other. A respective support structure may be arranged in each, or at least some, of the plurality of spaces to provide support to the respective coil segments.

The transformer may include more than two coil segments. For instance, the transformer may include at least three coil segments. A space may be formed between each of the at least three coil segments, respectively. The spaces formed between the at least three coil segments may extend at least in a radial direction, with respect to a longitudinal axis of the transformer and/or a winding axis of the coil segments. Thus, at least a first space formed between a first and a second of the at least three coil segments may be arranged within, in particular radially within, at least a second space formed between the second and a third of the at least three coil segments.

Thus, at least one support structure may be arranged in each of the spaces formed between the respective coil segments.

While the spaces, i.e., cooling ducts, formed between at least two coil segments of a transformer, as described above, may provide a cooling effect to the transformer by transferring heat from the coil segments to the fluid directed through the space(s), the support structure or the plurality of support structures may limit the cooling effect provided by the cooling ducts. In particular, the support structure(s) may take up a relatively large portion of the cross-sectional area(s) within the space(s) and may effect a resistance to the flow through the space(s), thereby inhibiting the cooling flow through the space(s).

In addition, transformers may also be provided with at least one coil block which is arranged on or near a top side and/or on or near a bottom side of the transformer, when the transformer is set up in an upright operational position. The at least one coil block may further provide support to the coils of the transformer, in particular when a short circuit occurs, in which case the coils of the concerned transformer may be subject to a relatively large force generated in the coils during the short circuit. Thus, in order to prevent damage, or to at least reduce the risk of damage, to the coils and/or to other components of the transformer, one or more coil blocks may be provided in the transformer.

However, the at least one coil block may block, or at least provide a substantial flow resistance to the fluid flowing in at least a portion of the space, i.e. the cooling duct, provided between the at least two coil segments. In particular, the at least one coil block may be connected to at least one of at least two coil segments, between which the space for the support structure is provided, and a further coil, in particular a coil which at least partially surrounds the at least two coil segments. In particular such an arrangement of the at least one coil block may compromise the efficiency and/or effectiveness of the cooling via the fluid flowing through the space, i.e., the cooling duct.

Thus, in order to enhance the cooling effect within the coil segments of the transformer, the support structure comprises at least one fluid passage opening provided in at least a section of the elongated body. The at least one fluid passage opening is configured to allow a fluid to pass therethrough from the first side of the elongated body to the second side of the elongated body.

By providing at least one fluid passage opening in the elongated body, the fluid in the space between the at least two coil segments may be redirected through the at least one fluid passage opening. This may allow the direction of the fluid to be changed, e.g., to a path with a reduced flow resistance, and/or the velocity of the fluid to be increased and/or the distance which the fluid covers to be increased. Thus, the cooling effect, i.e., the amount of heat transferred from the coil segments of the transformer and/or from the support structure, to the fluid, may be increased, in particular without significant additional costs. In particular, no additional material costs may be required.

Moreover, the increased cooling effect may allow a reduction of material costs, e.g., by being able to use lower-cost material due to the reduced heat in the transformer and the reduced heat resistance demands for the material.

Furthermore, the increased cooling effect may improve the reliability of the transformer.

Moreover, providing the enhanced cooling effects via the at least one fluid passage opening provided in the elongated body has little to no effect on the design and/or mechanical strength of the transformer.

The fluid may be a dielectric fluid. Moreover, the fluid may be a gas, e.g., air, or a liquid, e.g., mineral oil.

The first side of the elongated body may be an outwardly facing surface of the elongated body. In other words, the first side may at least partially form an outer circumference of the elongated body.

The second side of the elongated body may also be an outwardly facing surface of the elongated body. In other words, the second side may also at least partially former an outer circumference of the elongated body.

Alternatively, at least one of the first side and the second side of the elongated body may be an inwardly facing surface of the elongated body. This may particularly be the case when the elongated body has a closed, or at least semi-closed, profile, such as, but not limited to, a rectangular, round, or triangular profile when viewed in a cross-section which is substantially perpendicular to the longitudinal axis of the elongated body, i.e., along the longest side of the elongated body. For instance, the first side and/or the second side of the elongated body may be arranged at least partially on the inside of a hollow section of the elongated body.

The support structure, more specifically the elongated body, may be formed as a one-piece member. In other words, the support structure may be a single, integrally formed unit.

Alternatively, the support structure, more specifically the elongated body, may be assembled from a plurality of members. The members may be connected to each other via known connecting means, such as welding, adhesive bonding, clamps, rivets, bolts, and/or other known connecting means.

For instance, the support structure may be assembled from three members, including two end sections and an intermediate section connecting the two end sections. The configurations of the two end sections may be substantially identical or different. The configuration of the intermediate section may differ substantially from the configuration of at least one of the end sections, in particular of both end sections.

At least one of the end sections, in particular both end sections, may include at least one fluid passage opening formed therein. The intermediate section may not include any openings formed therein.

In such an arrangement, at least one of the end sections, in particular both end sections, may serve the purpose of providing an enhanced cooling effect via the at least one fluid passage opening formed therein by allowing a bypass fluid flow therethrough, while the intermediate section, which particularly does not include any openings, may substantially serve the purpose of providing rigidity and structural strength to the support structure.

The arrangement described above may provide a modular construction of the support structure. In this case, the support structure may be assembled to individually adapt to the needs and/or requirements in the specific application in a respective transformer, i.e., to different shapes and/or dimensions of the transformer and/or of the spaces, in which the support structure is to be arranged.

Thus, the support structure may be tailored according to the needs and/or requirements of the concerned application situation in a transformer by providing such a modular configuration of the support structure.

The support structure, more specifically the elongated body, may be made of any material. Particularly, the elongated body may be made of a material which may provide a sufficient rigidness and/or structural strength and/or heat resistance for providing support to the at least two coil segments of the transformer during operation.

In addition to heat being transferred directly from the at least two coil segments of the transformer to the fluid, heat may also be conducted from the at least two coil segments through the support structure. The heat conducted from the at least two coil segments through the support structure may then be transferred from the support structure to the fluid. For this purpose, the elongated body may be made of a material which has a relatively high thermal conductivity, e.g., a metal such as aluminum or copper, to efficiently transfer heat from the at least two coil segments of the transformer to the fluid. The elongated body may also have one or more ribs formed on at least one surface thereof to increase the heat transfer surface of the elongated body along which heat may be transferred to the fluid.

The elongated body may have two end sections and an intermediate section connecting the two end sections. Each of the end sections and the intermediate section may extend along the longitudinal axis of the elongated body. The at least one fluid passage opening may be provided in at least one of the end sections or the intermediate section.

The end sections and the intermediate section may be integrally formed. Alternatively, the end sections and the intermediate section may be assembled together, e.g., via known connecting means, such as welding, adhesive bonding, clamps, rivets, bolts, and/or other known connecting means, to provide a modular construction of the support structure.

Providing at least one fluid passage opening in at least one of the end sections or the intermediate section may allow the fluid provided in the space between the at least two coil segments of the transformer to flow along the longitudinal axis of the elongated body, i.e., along its length or longest side, to transfer heat from the at least two coil segments and/or the elongated body to the fluid.

The fluid may then flow through the at least one fluid passage opening provided in at least one of the end sections or the intermediate section, once the flow has reached the at least one fluid passage opening. This may enable the flow to change its flow path, e.g., in a direction with reduced flow resistance and/or in order to extend the flow path of the fluid. This may enable the fluid to reach regions which it may not reach if the at least one fluid passage opening were not provided, such as regions which are blocked by an object and/or in which the flow path to such regions is at least provided with a substantial flow resistance which is effected by the object. Such an object may be at least one coil block as described at the beginning. Such a flow resistance may be reduced by providing at least one fluid passage opening in the elongated body.

Thus, the flow path of the fluid may be at least in part determined and/or guided by the at least one fluid passage opening to increase the cooling efficiency and/or effectiveness of the fluid in the transformer.

The elongated body may have at least two fluid passage openings with at least one fluid passage opening in each end section. The end sections may in particular be arranged substantially adjacent to, or at least proximate, at least one coil block, in case a coil block is provided, the purposes of which are described at the beginning. Thus, by providing at least one fluid passage in each end section may enable the fluid to flow along the length of the support structure close to the coil block and then bypass the coil block by flowing through the at least one fluid passage in each end section.

Hence, the fluid may at least partially flow through regions of the space, i.e., cooling duct, which are proximate the coil block(s) in order to provide an enhanced cooling effect in such regions as well. This may prevent, or at least reduce, heat build up, often referred to as hot spots, in such regions in the transformer. This may increase the overall efficiency and/or effectiveness of the cooling in the transformer.

The elongated body may have at least three fluid passage openings with at least one further fluid passage opening provided in the intermediate section. The at least one further fluid passage opening provided in the intermediate section may further enhance the cooling efficiency and/or effectiveness of the fluid in the transformer by increasing the total available cross-sectional area for the fluid to bypass through the elongated body from a first side of the elongated body to a second side of the elongated body and by providing, in general, a fluid passage opening in a further section of the elongated body, i.e., in the intermediate section.

This may increase the turbulence and/or decrease the flow boundary layer of the fluid in the space provided between the at least two coil segments of the transformer due to the change of direction of the fluid through the at least one further fluid passage opening provided in the intermediate section. Such a configuration may also increase the area covered by the fluid and the mixing of the fluid in the space, i.e., the cooling duct. In any case, this may increase the heat transfer from the at least two coil segments and from the support structure to the fluid.

The at least one fluid passage opening may be at least partially arranged in the space provided between the at least two coil segments, when the support structure is arranged in the space.

By providing the at least one fluid passage opening to be at least partially arranged in the space provided between the at least two coil segments, when the support structure is arranged in the space, the effectiveness and/or efficiency of the at least one fluid passage opening in enhancing the cooling performance of the fluid in the space provided between the at least two coil segments of the transformer may be increased.

The elongated body may extend along a longitudinal axis which is substantially parallel to a winding axis of the at least two coils segments and/or a longitudinal axis of the transformer, when the support structure is arranged in the space between the at least two coils segments. Thus, in such an arrangement of the elongated body, the longest side of the elongated body may extend substantially parallel to a winding axis of the at least two coils segments and/or a longitudinal axis of the transformer.

For one, such an arrangement of the elongated body may increase the structural support provided to the at least two coil segments by the support structure since this may allow the support structure to support the least two coil segments along the entire winding axis and/or a longitudinal axis of the transformer.

This may also increase the heat transfer from the support structure to the fluid. In particular, natural convection causes the fluid to flow from the bottom of the transformer to the top of the transformer, when the winding axis of the at least two coils segments and/or a longitudinal axis of the transformer are in a vertical position when the transformer is in an operating position. Thus, natural convection may cause the fluid to flow along the length, i.e., the longest side, of the elongated body, which may increase the amount of heat which can be transferred to the fluid.

The support structure may be configured to provide a predetermined space between the at least two coil segments, when the support structure is arranged in the space between the at least two coil segments.

As detailed at the beginning, the support structure serves the main purpose of providing support to the coil segments of the transformer, in particular when the coil segments are subjected to forces which may move and/or displace the coil segments. In particular when a short circuit occurs, the coil segments may be subjected to a force generated in the coils during the short circuit.

Thus, providing a predetermined space between the at least two coil segments, when the support structure is arranged in the space between the at least two coil segments, may prevent the at least two coil segments from being displaced towards each other, thus preventing damage to the at least two coil segments or at least reducing the risk of damage thereto.

The at least one fluid passage opening may extend through the elongated body in a direction which is substantially perpendicular to a longitudinal axis of the elongated body.

The at least one fluid passage opening may extend through the elongated body in a plurality of different directions, wherein at least one of the directions is substantially perpendicular to the longitudinal axis of the elongated body. In other words, the at least one fluid passage opening does not necessarily have to extend straight through the elongated body. However, the at least one fluid passage may extend straight through the elongated body.

By configuring the at least one fluid passage opening to extend through the elongated body in a direction which is substantially perpendicular to the longitudinal axis of the elongated body, a portion of the flow path of the fluid in the space between at least two coils segments of a transformer may be forced to also extend in a direction which is substantially, or at least close to being, perpendicular to the longitudinal axis of the elongated body. This may further enhance the cooling efficiency and/or effectiveness of the fluid in the transformer, e.g., by increasing the turbulence and/or decreasing the flow boundary layer of the fluid in the space provided between the at least two coil segments of the transformer due to the change of direction of the fluid through the at least one further fluid passage opening provided in the intermediate section. Such an orientation of the at least one fluid passage opening may also increase the overall mixing of fluid between two adjacent support structures, in case a plurality of support structures are provided in the space provided between the at least two coil segments of the transformer.

In any case, this may increase the heat transfer from the at least two coil segments and from the support structure to the fluid.

The at least one fluid passage opening may be oriented relative to a winding axis of the at least two coil segments and/or to a longitudinal axis of the transformer, when the support structure is arranged in the space between the at least two coil segments, such that the fluid passing through the at least one fluid passage opening at least has a flow velocity component which is angled relative to the winding axis and/or to the longitudinal axis of the transformer, particularly by at least 20°, more particularly by at least 30°, more particularly by at least 45°, more particularly by at least 60°, most particularly by at least 75°.

Providing an angle between the flow of the fluid relative to the winding axis and/or to the longitudinal axis of the transformer may further enhance the cooling efficiency and/or effectiveness of the fluid in the transformer, e.g., by increasing the turbulence and/or decreasing the flow boundary layer of the fluid in the space provided between the at least two coil segments of the transformer due to the change of direction of the fluid through the at least one further fluid passage opening provided in the intermediate section. Such an angle of the fluid relative to the winding axis and/or to the longitudinal axis of the transformer may also increase the overall mixing of fluid between two adjacent support structures, in case a plurality of support structures are provided in the space provided between the at least two coil segments of the transformer. In any case, this may further increase the heat transfer from the at least two coil segments and the support structure to the fluid.

A cross-section of the at least one fluid passage opening and a winding axis of the at least two coil segments, and particularly a longitudinal axis of the transformer, may substantially lie in a single plane. Hence, the flow of the fluid may be directed to be substantially perpendicular to the winding axis of the at least two coil segments, and particularly the longitudinal axis of the transformer. This may further enhance the cooling efficiency and/or effectiveness of the fluid in the transformer, e.g., by increasing the turbulence and/or decreasing the flow boundary layer of the fluid in the space provided between the at least two coil segments of the transformer due to the change of direction of the fluid through the at least one further fluid passage opening provided in the intermediate section. Directing the flow of the fluid may be directed to be substantially perpendicular to the winding axis of the at least two coil segments, and particularly the longitudinal axis of the transformer may also increase the overall mixing of fluid between two adjacent support structures, in case a plurality of support structures are provided in the space provided between the at least two coil segments of the transformer. This may increase the heat transfer from the support structure to the fluid.

Thus, the flow of the fluid through the at least one fluid passage opening may be substantially in a circumferential direction, in particular about the winding axis and/or the longitudinal axis of the transformer. By providing such an orientation of the fluid flow one or more coil blocks, if provided, may be efficiently and effectively bypassed. This may increase the heat transfer from the at least two coil segments and the support structure to the fluid.

The elongated body may have a cross-sectional shape of one of the following: T-shape, I-shape, H-shape, C-shape, rectangular shape and rectangular shape, particularly with rounded corners. The cross-section may be substantially perpendicular to the longitudinal axis of the elongated body, i.e., along the longest side of the elongated body. The elongated body may not be limited to the above-recited cross-sectional shapes. In fact, the elongated body may have any cross-sectional shape. Moreover, the elongated body may have a plurality of different cross-sectional shape along its longitudinal axis, i.e., its longest side.

The elongated body may have a length from 200 mm to 2000 mm, particularly from 500 to 1500 mm

The at least one fluid passage opening may have a shape with a closed circumference, particularly a round, oval, rectangular, triangular or polygonal shape.

Additionally, or alternatively, the at least one fluid passage opening may be formed along at least one edge of the elongated body such that the at least one fluid passage opening is open along a section of a circumference of the fluid passage opening.

In particular, at least one fluid passage opening may be formed at least along a distal edge of at least one of the end sections of the elongated body, particularly both end sections. This may be particularly effective in bypassing a coil block, if a coil block is installed in the transformer, from the first side to the second side of the elongated body.

The total cross-sectional area of all of the fluid passage openings provided in the support structure may be at least 40 mm2, particularly at least 60 mm2, more particularly at least 80 mm2, particularly at least 100 mm2, most particularly at least 120 mm2.

By providing such a minimum total cross-sectional area of all of the fluid passage openings provided in the support structure, a sufficiently large amount of fluid bypass flow through the fluid passage openings may be ensured to increase the efficiency and/of effectiveness of the cooling of the transformer.

The elongated body may have a plurality of fluid passage openings, cross-sections of the fluid passage openings particularly lying in a single plane.

Each end section may comprise a plurality of fluid passage openings. In particular, cross-sections of the fluid passage openings may lie in a single plane. Alternatively, or additionally, the distance between two adjacent fluid passage openings of the plurality of fluid passage openings in each of the end sections may be from 5 mm to 20 mm, particularly from 8 mm to 12 mm.

The elongated body may be made of metal, particularly aluminum, or a fiber composite material. The elongated may be made of other material(s).

Particularly, the elongated body may be made of a material which may provide a sufficient rigidness and/or structural strength and/or heat resistance for providing support to the at least two coil segments of the transformer during operation.

In addition to heat being transferred directly from the at least two coil segments of the transformer to the fluid, heat may also be conducted from the at least two coil segments through the support structure. The heat conducted from the at least two coil segments through the support structure may then be transferred from the support structure to the fluid. For this purpose, the elongated body may be made of a material which has a relatively high thermal conductivity, e.g., a metal such as aluminum or copper, to efficiently transfer heat from the at least two coil segments of the transformer to the fluid. The elongated body may also have one or more ribs formed on at least one surface thereof to increase the heat transfer surface of the elongated body along which heat may be transferred to the fluid.

The present disclosure further relates to a transformer according to a second aspect of the disclosure.

The features, configurations and advantages described herein in connection with the support structure according to the first aspect of the disclosure also apply to the transformer according to a second aspect of the disclosure accordingly.

The transformer comprises a core and at least two coil segments arranged at least partially around the core. The transformer further comprises at least one support structure having any of the features and/or configurations described herein. The at least one support structure is arranged at least partially in a space between the at least two coil segments.

The transformer may be an oil filled transformer or a dry transformer.

The following list of aspects provides alternative and/or further features of the disclosure:

1. A support structure configured to be arranged at least partially in a space provided within a transformer, in particular to provide support to at least one coil of the transformer, particularly in a space provided between at least two coil segments of a transformer to provide support to the at least two coil segments, the support structure comprising:
an elongated body having at least a first side and a second side; and
at least one fluid passage opening provided in at least a section of the elongated body, the at least one fluid passage opening being configured to allow a fluid to pass therethrough, particularly from the first side of the elongated body to the second side of the elongated body.

2. The support structure according to aspect 1, wherein the elongated body has two end sections and an intermediate section connecting the two end sections, each of the end sections and the intermediate section particularly extending along a longitudinal axis of the elongated body, wherein the at least one fluid passage opening is provided in at least one of the end sections or the intermediate section, particularly the elongated body having at least two fluid passage openings with at least one fluid passage in each end section, and more particularly the elongated body having at least three fluid passage openings with at least one further fluid passage opening provided in the intermediate section.

3. The support structure according to aspect 1 or 2, wherein the at least one fluid passage opening is at least partially arranged in the space provided within the transformer, particularly in the space provided between the at least two coil segments, when the support structure is arranged in the space.

4. The support structure according to any of the preceding aspects, wherein the elongated body extends along a longitudinal axis which is substantially parallel to a winding axis of the at least two coil segments and/or a longitudinal axis of the transformer, when the support structure is arranged in the space between the at least two coil segments.

5. The support structure according to any of the preceding aspects, wherein the support structure is configured to provide a predetermined distance between the at least two coil segments, in at least a section thereof, when the support structure is arranged in the space between the at least two coil segments.

6. The support structure according to any of the preceding aspects, wherein the at least one fluid passage opening extends through the elongated body in a direction which is substantially perpendicular to a longitudinal axis of the elongated body.

7. The support structure according to any of the preceding aspects, wherein the at least one fluid passage opening is oriented relative to a winding axis of the at least two coil segments and/or to a longitudinal axis of the transformer, when the support structure is arranged in the space between the at least two coil segments, such that the fluid passing through the at least one fluid passage opening at least has a flow velocity component which is angled relative to the winding axis and/or to the longitudinal axis of the transformer, particularly by at least 20°, more particularly by at least 30°, more particularly by at least 45°, more particularly by at least 60°, most particularly by at least 75°.

8. The support structure according to any of the preceding aspects, wherein a cross-section of the at least one fluid passage opening and a winding axis of the at least two coil segments, and particularly a longitudinal axis of the transformer, substantially lie in a single plane.

9. The support structure according to any of the preceding aspects, wherein the elongated body has a cross-sectional shape of one of the following: T-shape, I-shape, H-shape, C-shape, rectangular shape and rectangular shape, particularly with rounded corners.

10. The support structure according to any of the preceding aspects, wherein the length of the elongated body is from 200 mm to 2000 mm, particularly from 500 to 1500 mm.

11. The support structure according to any of the preceding aspects, wherein the at least one fluid passage opening has a shape with a closed circumference, particularly a round, oval, rectangular, triangular or polygonal shape;
and/or
wherein the at least one fluid passage opening is formed along at least one edge of the elongated body such that the at least one fluid passage opening is open along a section of a circumference of the fluid passage opening.

12. The support structure according to any of the preceding aspects, wherein the at least one fluid passage opening has a cross-sectional area of at least 20 mm2, particularly at least 40 mm2, more particularly at least 60 mm2, particularly at least 80 mm2, most particularly at least 100 mm2.

13. The support structure according to any of the preceding aspects, wherein the elongated body has a plurality of fluid passage openings, cross-sections of the fluid passage openings particularly lying in a single plane.

14. The support structure according to any of aspects 2 to 13, wherein each end section comprises a plurality of fluid passage openings, wherein
particularly, cross-sections of the fluid passage openings lie in a single plane; and/or
particularly, the distance between two adjacent fluid passage openings of the plurality of fluid passage openings in each of the end sections is from 5 mm to 20 mm, particularly from 8 mm to 12 mm.

15. The support structure according to any of the preceding aspects, wherein the elongated body is made of metal, particularly aluminum, or a fiber composite material.

16. A transformer comprising:
a core;
at least two coil segments arranged at least partially around the core; and
at least one support structure according to any of the preceding aspects being arranged at least partially in a space between the at least two coil segments.

17. The transformer according to aspect 16, wherein the transformer is an oil filled transformer or a dry transformer.

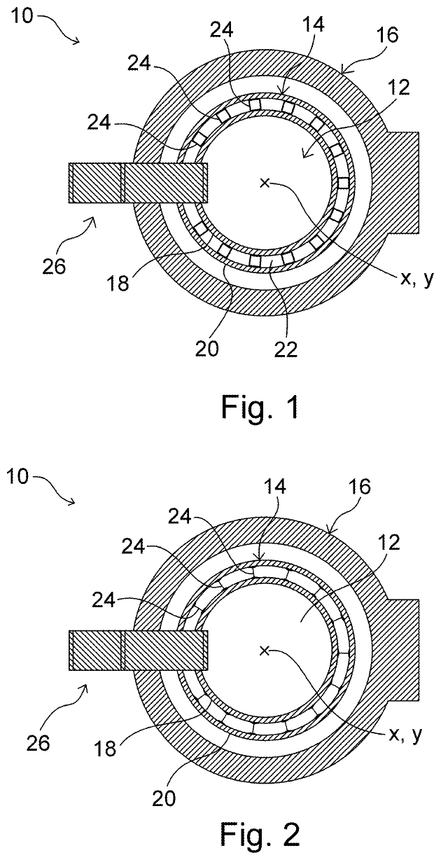

FIGS. 1 and 2 show a transformer 10 with a core 12, a first coil 14 arranged at least partially around the core 12, and a second coil 16 arranged at least partially around the first coil 14. The coils 14, 16 are wound about a winding axis x, which is also coincides with a longitudinal axis y of the transformer 10. Thus, the second coil 16 is arranged radially outside of the first coil 14, with respect to the winding axis x and the longitudinal axis y. The winding axis x and the longitudinal axis y of the transformer 10 do not have to coincide. Alternatively, the winding axis x and the longitudinal axis y of the transformer 10 may extend parallel to each other or may extend at an angle to each other. Based on the perspectives shown in FIGS. 1 and 2, the winding axis x and the longitudinal axis y extend perpendicularly into the drawing plane.

The first coil 14 may be a primary coil winding and the second coil 16 may be a secondary coil winding. Alternatively, the second coil 16 may be a primary coil winding and the first coil 14 may be a secondary coil winding.

The first coil 14 may be a low voltage (LV) coil winding and the second coil 16 may be a high voltage (HV) coil winding of the transformer 10, wherein the low voltage coil winding has a lower voltage than the high voltage coil winding. Alternatively, the first coil 14 may be a high voltage coil winding and the second coil 16 may be a low voltage coil winding of the transformer 10.

The first coil 14 comprises a first coil segment 18 and a second coil segment 20 which is arranged at least partially around the first coil segment 18 in a radial directions, with respect to the winding axis x and the longitudinal axis y. The coil segments 18, 20 define a space 22 formed therebetween.

The space 22 is a radial space extending radially between the first coil segment 18 and the second coil segment 20, with respect to the winding axis x and the longitudinal axis y. The space 22 further extends substantially circumferentially about the winding axis x and the longitudinal axis y of the transformer 10. The space 22 also extends axially, at least partially, along the winding axis x and the longitudinal axis y of the transformer 10.

The transformer 10 may include more than two coil segments 18, 20. For instance, the transformer 10 may include at least three coil segments. A space may be formed between each of the at least three coil segments, respectively. The spaces formed between the at least three coil segments may extend at least in a radial direction, with respect to a longitudinal axis of the transformer 10 and/or a winding axis x of the coil segments. Thus, at least a first space formed between a first and a second of the at least three coil segments may be arranged within, in particular radially within, at least a second space formed between the second and a third of the at least three coil segments.

Thus, at least one support structure 24 may be arranged in each of the spaces formed between the respective coil segments.

The space 22 may be configured as a cooling duct to allow a fluid, such as a gas or a liquid, to at least partially flow therethrough in order to transfer heat away from the coil segments 18, 20. Further cooling ducts may be arranged elsewhere in the transformer 10, for instance, within the core 12, to provide further cooling means.

In order to provide support to the first coil segment 18 and the second coil segment 20, a plurality of support structures 24 are provided in the space 22 defined between the coil segments 18, 20. In particular, the support structures 24 may be configured to provide a predetermined space between the coil segments 18, 20, when the support structures 24 are arranged in the space 22 between the at least two coil segments 18, 20.

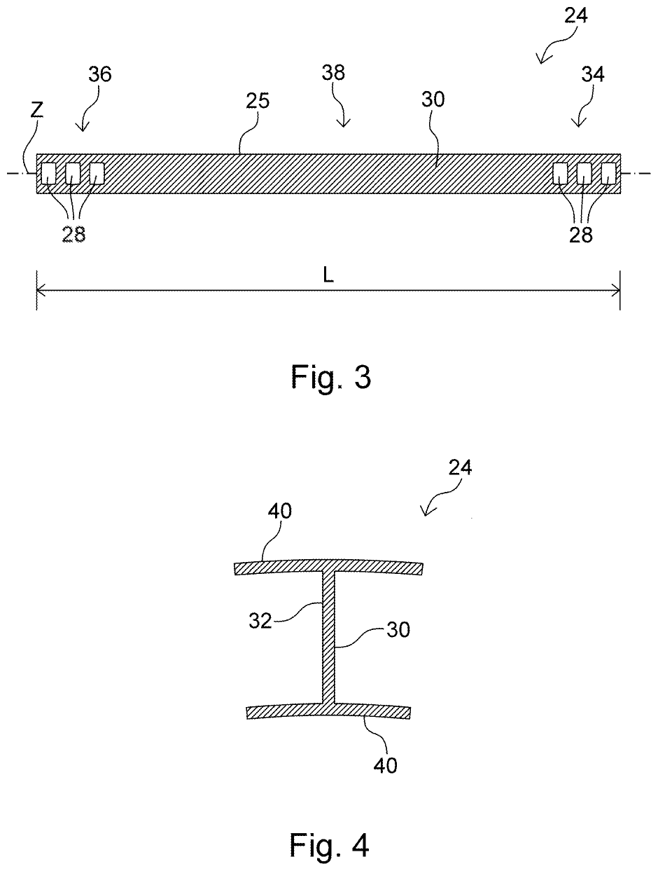

The support structures 24 have an elongated body 25 having a longitudinal axis z extending along a length L of the elongated body 25 (see FIG. 3).

The support structures 24, more specifically the elongated bodies 25 thereof, may be made of any material. Particularly, the elongated body 25 may be made of a material which may provide a sufficient rigidness and/or structural strength and/or heat resistance for providing support to the coil segments 18, 20 of the transformer 10 during operation.

In addition to heat being transferred directly from the coil segments 18, 20 of the transformer 10 to the fluid, heat may also be conducted from the coil segments 18, 20 through the support structure 24. The heat conducted from the coil segments 18, 20 through the support structure 24 may then be transferred from the support structure 24 to the fluid. For this purpose, the elongated body 25 may be made of a material which has a relatively high thermal conductivity, e.g., a metal such as aluminum or copper, to efficiently transfer heat from the coil segments 18, 20 of the transformer 10 to the fluid. The elongated body 25 may also have one or more ribs (not shown) formed on at least one surface thereof to increase the heat transfer surface of the elongated body 25 along which heat may be transferred to the fluid.

In particular, the elongated body 25 may be made of metal, particularly aluminum, or a fiber composite material.

The longitudinal axis z of the elongated body 25 may be substantially parallel to the winding axis x of the coil segments 18, 20 and the longitudinal axis y of the transformer 10, when the support structure 24 is arranged in the space 22 between the coil segments 18, 20.

According to the configuration shown in FIG. 1, the support structures 24 each have a closed profile with a rectangular cross-sectional shape. Closed profiles with other cross-sectional shapes may also be used, such as a round, oval, triangular or polygonal cross-sectional shapes.

By contrast to the configuration shown in FIG. 1, the support structures 24 shown in the configuration of FIG. 2 each have an open profile with a substantially I-shaped cross-sectional shape. Open profiles with other cross-sectional shapes may also be used, such as T-shaped, H-shaped, C-shaped, rectangular shaped and rectangular shaped, particularly with rounded corners, cross-sectional shapes

The transformers 10 shown in FIGS. 1 and 2 further include a coil block 26 arranged on a top side of the respective transformer 10. Though not specifically shown in FIGS. 1 and 2, the transformers 10 may include a plurality of coil blocks 26 arranged on a top side of the transformers 10 and one or more coil blocks 26 arranged on a bottom side of the transformers 10. The coil block 26 may be connected to at least one of the coil segments 18, 20 of the coil 14 and to the coil 16. The coil block 26 may further provide support to the coils 14, 16 of the transformer 10, in particular when a short circuit occurs, in which case the coils 14, 16 of the transformer 10 may be subjected to a relatively large force generated in the coils 14, 16 during the short circuit. Thus, in order to prevent damage, or to at least reduce the risk of damage, to the coils 14, 16 and/or to other components of the transformer 10, one or more coil blocks 26 may be provided in the transformer 10 in order to provide support and stability to the coils 14, 16.

As can be seen in FIGS. 1 and 2, the support structures 24 take up a relatively large portion of the cross-sectional area of the space 22 through which the fluid may flow in order absorb heat from the support structures 24 and the coil segments 18, 20. This may inhibit the cooling efficiency and/or effectiveness of the fluid flowing through the space 22.

Moreover, as can also be seen in FIGS. 1 and 2, the coil block 26 blocks, or at least provides a substantial flow resistance to the fluid flowing in at least a portion of the space 22, at least in an axial direction along the longitudinal axis y of the transformer 10. Thus, while the coil block 26 may be beneficial to the structural stability of the transformer 10, the coil block 26 compromises the efficiency and/or effectiveness of the cooling via the fluid flowing through the space 22.

Thus, in order to enhance the cooling effect within the coil segments 18, 20 of the transformer 10, the elongated body 25 of the support structure 24 has at least one fluid passage opening 28 arranged in the elongated body 25. According to the embodiment shown in FIG. 3, the elongated body 25 of the support structure 24 comprises a total of six fluid passage openings 28. The fluid passage openings 28 are configured to allow a fluid to pass through the fluid passage openings 28 from a first side 30 of the elongated body 28 to a second side 32 (see FIG. 4) of the elongated body 25.

The fluid passage openings 28 are illustrated as being substantially round. However, the fluid passage openings 28 may be of any other shape, e.g., oval, rectangular, triangular or polygonal.

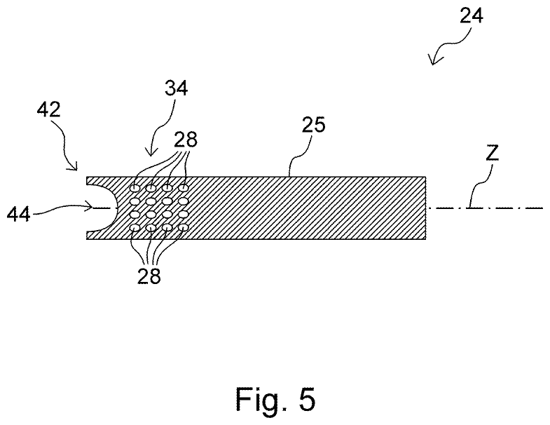

The fluid passage openings 28 shown in FIG. 3 have a closed circumference. However, the fluid passage openings 28 may also be formed along at least one edge 42 of the elongated body 25 such that the at least one fluid passage opening 28 is open along a section of a circumference 44 of the fluid passage opening 28 (see FIG. 5).

The elongated body 25 has two end sections 34, 36 and an intermediate section 38 connecting the two end sections 34, 36, each of the end sections 34, 36 and the intermediate section 38 extending along the longitudinal axis z. Each end section 34, 36 comprises three fluid passage openings 28 defined therein. Each end section 34, 36 may comprise more or less than three fluid passage openings 28. The end sections 34, 36 may not comprise any fluid passage openings 28 formed therein. Instead, the intermediate section 38 may have one or more fluid passage openings 28 formed therein.

Alternatively, the end sections 34, 36 and the intermediate section 38 may each have one or more fluid passage openings 28 formed therein, respectively.

Particularly, the entire elongated body 25 may have fluid passage openings 28 formed along its length L, the fluid passage openings 28 particularly being spaced evenly along the length L.

The fluid passage openings 28 may extend through the elongated body 25 in a direction which is substantially perpendicular to the longitudinal axis z of the elongated body 25.

The elongated body 25 may have any cross-sectional shape. For instance, the elongated body 25 may have an I-shaped cross-sectional shape (see FIG. 4). However, the elongated body 25 may have other cross-sectional shapes, such as a T-shape, H-shape, C-shape, rectangular shape and rectangular shape, particularly with rounded corners.

As can be seen in FIG. 4, the elongated body 25 may include support surfaces 40 configured to support, e.g., by contacting, the coil segments 18, 20.

As can be seen in FIG. 5, the support structure 24 may include several rows of substantially round-shaped fluid passage openings 28 arranged side by side at least on one end section 34.

Moreover, according to the embodiment shown in FIG. 5, a further fluid passage openings 28a is formed along at least an edge 42 of the elongated body 25 such that the at least one fluid passage opening 28a is open along a section of a circumference 44 of the fluid passage opening 28a.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A support structure configured to be arranged at least partially in a space provided between at least two coil segments of a transformer, the support structure comprising:
an elongated body having at least a first side and a second side; and
at least one fluid passage opening provided in at least a section of the elongated body, the at least one fluid passage opening being configured to allow a fluid to pass therethrough from the first side to the second side.

2. The support structure according to claim 1, wherein the elongated body has two end sections and an intermediate section connecting the two end sections, wherein the at least one fluid passage opening is provided in at least one of the end sections or the intermediate section.

3. The support structure according to claim 1, wherein the at least one fluid passage opening is at least partially arranged in the space provided between the at least two coil segments, when the support structure is arranged in the space.

4. The support structure according to claim 1, wherein the elongated body extends along a longitudinal axis which is substantially parallel to a winding axis of the at least two coil segments and/or a longitudinal axis of the transformer, when the support structure is arranged in the space between the at least two coil segments.

5. The support structure according to claim 1, wherein the support structure is configured to provide a predetermined space between the at least two coil segments, when the support structure is arranged in the space between the at least two coil segments.

6. The support structure according to claim 1, wherein the at least one fluid passage opening extends through the elongated body in a direction which is substantially perpendicular to a longitudinal axis of the elongated body.

7. The support structure according to claim 1, wherein the at least one fluid passage opening is oriented relative to a winding axis of the at least two coil segments and/or to a longitudinal axis of the transformer, when the support structure is arranged in the space between the at least two coil segments, such that the fluid passing through the at least one fluid passage opening at least has a flow velocity component which is angled relative to the winding axis and/or to the longitudinal axis of the transformer; by at least 20°.

8. The support structure according to claim 1, wherein a cross-section of the at least one fluid passage opening and a winding axis of the at least two coil segments substantially lie in a single plane.

9. The support structure according to claim 1, wherein the elongated body has a cross-sectional shape of one of the following: T-shape, I-shape, H-shape, C-shape, rectangular shape and rectangular shape.

10. The support structure according to claim 1, wherein the elongated body has a length from 200 mm to 2000 mm.

11. The support structure according to claim 1, wherein the at least one fluid passage opening has a shape with a closed circumference.

12. The support structure according to claim 1, wherein the total cross-sectional area of all of the fluid passage openings provided in the support structure is at least 40 mm2, particularly at least 60 mm2, more particularly at least 80 mm2, particularly at least 100 mm2, most particularly at least 120 mm2.

13. The support structure according to claim 1, wherein the elongated body has a plurality of fluid passage openings, cross-sections of the fluid passage openings particularly lying in a single plane.

14. The support structure according to claim 2, wherein each end section comprises a plurality of fluid passage openings, wherein
particularly, cross-sections of the fluid passage openings lie in a single plane; and/or
particularly, the distance between two adjacent fluid passage openings of the plurality of fluid passage openings in each of the end sections is from 5 mm to 20 mm, particularly from 8 mm to 12 mm.

15. The support structure according to claim 1, wherein the elongated body is made of metal, particularly aluminum, or a fiber composite material.

16. A transformer comprising:
a core;
at least two coil segments arranged at least partially around the core; and
at least one support structure being arranged at least partially in a space between the at least two coil segments, the at least one support structure comprising:
an elongated body having at least a first side and a second side; and
at least one fluid passage opening provided in at least a section of the elongated body, the at least one fluid passage opening being configured to allow a fluid to pass therethrough from the first side to the second side.

17. The transformer according to claim 16, wherein the transformer is an oil filled transformer or a dry transformer.

18. The support structure according to claim 1, the elongated body having at least two fluid passage openings with at least one fluid passage opening in each end section, and more particularly the elongated body having at least three fluid passage openings with at least one further fluid passage opening provided in the intermediate section.

19. The support structure according to claim 1, wherein the at least one fluid passage opening is formed along at least one edge of the elongated body such that the at least one fluid passage opening is open along a section of a circumference of the fluid passage opening.

20. A method comprising:
arranging at least two coil segments at least partially around a core of a transformer; and
arranging at least one support structure at least partially in a space between the at least two coil segments, the at least one support structure comprising:
an elongated body having at least a first side and a second side; and
at least one fluid passage opening provided in at least a section of the elongated body, the at least one fluid passage opening being configured to allow a fluid to pass therethrough from the first side to the second side.
